(19) United States
(12) Patent Application Publication
(10) Pub. No.: US 2024/0351688 A1
(43) Pub. Date: Oct. 24, 2024

(54) AIRCRAFT GALLEY, AND METHOD AND APPARATUS FOR CONFIGURING AIRCRAFT GALLEY

(71) Applicant: The Boeing Company, Arlington, VA (US)

(72) Inventors: Paola Trapani, Shanghai (CN); Jiao Mo, Shanghai (CN); Ke Ma, Shanghai (CN); Peizhong Gao, Shanghai (CN); Qian Guo, Shanghai (CN); Yiqin Zhang, Shanghai (CN); Youjia Shen, Shanghai (CN); Jiawen Huang, Shanghai (CN); Daniel Wei, Beijing (CN); Cynthia A. Vandewall, Snohomish, WA (US)

(73) Assignee: The Boeing Company, Arlington, VA (US)

(21) Appl. No.: 18/583,131

(22) Filed: Feb. 21, 2024

(30) Foreign Application Priority Data
Apr. 23, 2023 (CN) 2023104426977

(51) Int. Cl. B64D 11/04; B64D 11/00

(52) U.S. Cl. CPC B64D 11/04; B64D 2011/0046

(57) ABSTRACT

The present invention relates to an aircraft galley, and a method and apparatus for configuring the same. The aircraft galley includes: a frame attached to walls of a cabin of an aircraft in a horizontal direction and has an open accommodating space; one or more first to third cabinet assemblies all detachably connected to the frame, wherein the sizes of the first to third cabinet assemblies and the accommodating space are in a predetermined proportion to each other, such that the space can be filled with different combinations formed by at least two of the first to third cabinet assemblies, and the different combinations differ in at least one of: types of cabinet assemblies, the number of each type of the cabinet assemblies, and the arranged position of each cabinet assembly. Therefore, the technical effects of improving the utilization efficiency of the aircraft galley and reducing airline costs are achieved.

### PRIORITY

This application claims priority from Chinese Pat. App. No. 2023104426977 filed on Apr. 23, 2023, the entire contents of which are incorporated herein by reference.

### FIELD

The present application relates to an aircraft galley, and more particularly, to an aircraft galley having sharable standardized cabinet assemblies, and a method and apparatus for configuring the aircraft galley.

### BACKGROUND

Existing aircraft galleys generally employ fixed structures and are equipped with fixed equipment for supplying aircraft meals. Thus, once installed on an aircraft, the aircraft galley occupies a fixed space and has an almost fixed weight, thereby occupying a fixed cost of an airline. However, with changes in flight duration, the number of passengers and the like, the storage space in the aircraft galley is often not in a full-load state, and the equipment in the aircraft galley sometimes provides services and sometimes does not. For example, for a flight with a duration of less than two hours, the airline typically does not supply meals, or only supplies pre-packaged snacks and water at room temperature. In this case, a large area of empty meal storage space and unused fixed equipment (such as a microwave oven or the like) in the aircraft galley cause low utilization efficiency of the aircraft galley and waste of aircraft space.

The airline requires a better way to configure the valuable space occupied by the aircraft galley, so as to improve the utilization efficiency of the galley, reduce the airline costs and provide personalized services, so as to adapt to the changing market.

### SUMMARY

The present application is proposed in view of the above-mentioned problems. The main objective of the present application is to provide an aircraft galley with sharable standardized cabinet assemblies, and a method and apparatus for configuring the aircraft galley, so as to at least solve the technical problems in the prior art that it is difficult to improve the utilization efficiency of the aircraft galley, reduce the operation cost of an airline, provide personalized services, and improve the economic and environmental benefits of the airline.

In order to achieve the above objectives, according to one aspect of the present application, provided is an aircraft galley, including: a frame, which is attached to walls of a cabin of an aircraft in a horizontal axis direction of the aircraft and has an open accommodating space, wherein the accommodating space has a predetermined width in the horizontal axis direction, a predetermined length in a longitudinal axis direction of the aircraft, and a predetermined height in a vertical axis direction of the aircraft; one or more first cabinet assemblies, which are detachably connected to the frame; one or more second cabinet assemblies, which are detachably connected to the frame; and one or more third cabinet assemblies, which are detachably connected to the frame, wherein the sizes of the first cabinet assembly, the second cabinet assembly, the third cabinet assembly, and the accommodating space are in a predetermined proportion to each other, such that the accommodating space may be filled with different combinations formed by at least two of the first cabinet assemblies, the second cabinet assemblies, and the third cabinet assemblies, and the different combinations differ in at least one of the following aspects: types of cabinet assemblies, the number of each type of cabinet assemblies, and the arranged position of each cabinet assembly in each type of cabinet assemblies.

Further, according to one embodiment of the present application, the accommodating space of the aircraft galley may be filled with different combinations formed by at least two of the first cabinet assemblies, the second cabinet assemblies, and the third cabinet assemblies includes: the accommodating space can be fully filled with different combinations formed by at least two of the first cabinet assemblies, the second cabinet assemblies, and the third cabinet assemblies.

Further, according to one embodiment of the present application, the first cabinet assembly may be detachably connected to the second cabinet assembly.

Further, according to one embodiment of the present application, the first cabinet assembly may be detachably connected to the second cabinet assembly in a snap-fit manner, and wheels are installed at the bottom of the first cabinet assembly, so as to be easily pulled out the first cabinet assembly from the frame.

Further, according to one embodiment of the present application, the sizes of the first cabinet assembly, the second cabinet assembly, and the third cabinet assembly being in the predetermined proportion to each other includes: the first cabinet assembly, the second cabinet assembly, and the third cabinet assembly have the same width in the horizontal axis direction, and the length of the second cabinet assembly in the longitudinal axis direction is half of the length of the first cabinet assembly in the longitudinal axis direction.

Further, according to one embodiment of the present application, the sizes of the first cabinet assembly, the second cabinet assembly, and the third cabinet assembly being in the predetermined proportion to each other includes: the first cabinet assembly and the third cabinet assembly has the same size, and the first cabinet assembly and the third cabinet assembly have different structural compositions.

Further, according to one embodiment of the present application, the first cabinet assembly and the third cabinet assembly having different structural compositions includes: the first cabinet assembly includes two identical cuboid units and a housing covering the two cuboid units, and the third cabinet assembly includes a single cuboid unit.

Further, according to one embodiment of the present application, each of the first cabinet assembly, the second cabinet assembly and the third cabinet assembly is used for storing a predetermined type of object, and the object includes any one of the following: meals, garbage, electrical equipment for the galley, baggage, and pets.

Further, according to one embodiment of the present application, at least one of the first cabinet assembly, the second cabinet assembly, and the third cabinet assembly further includes a sensor, and the sensor is disposed on an inner wall of the corresponding cabinet assembly and is configured to monitor amount of inventory of object stored in the corresponding cabinet assembly.

Further, according to one embodiment of the present application, combination, which is used for filling the accommodating space and is formed by at least two of the first cabinet assemblies, the second cabinet assemblies, and the third cabinet assemblies, varies with the flight of the aircraft.

Further, according to one embodiment of the present application, the combination, which is used for filling the accommodating space and is formed by at least two of the first cabinet assemblies, the second cabinet assemblies, and the third cabinet assemblies, is determined based on the information on a flight to be executed by the aircraft and configuration requirement of an airline for the flight, the information on the flight includes departure date and time, origin and destination, flight duration and a passenger list, and the configuration requirement for the flight comprises at least one of the following: whether meals are required, the types and quantities of the required meals, whether baggage deposit is required, the size of a space required for baggage deposit, whether pet deposit is required, and the size of a space required for pet deposit.

According to another aspect of the present application, further provided is a method for configuring an aircraft galley, including: receiving a catering configuration request from an airline for a flight to be executed by an aircraft and information on the flight, wherein the information on the flight comprises departure date and time, origin and destination, flight duration, and a passenger list; generating a knowledge graph of group passengers corresponding to the flight based on the information on the flight and stored knowledge graphs of individual passengers, wherein the knowledge graph of an individual passenger indicates a personalized catering preference of the passenger, and the knowledge graph of the group passengers indicates a clustered catering preference of the passengers on the flight; generating an initial meal configuration for the flight based on the information on the flight and the knowledge graph of the group passengers, wherein the initial meal configuration indicates the name of each meal recommended to be supplied on the flight and the quantities of corresponding meals; acquiring an accommodating space of the aircraft galley and an airport meal inventory of a departure airport for the flight, wherein the airport meal inventory comprises the types and quantities of meals available at the departure airport; modifying the initial meal configuration based on the airport meal inventory and the accommodating space, so as to obtain a final meal configuration; acquiring a cabinet assembly inventory of the departure airport, wherein the cabinet assembly inventory comprises the number of each of first cabinet assemblies, second cabinet assemblies, and third cabinet assemblies, which are available at the departure airport; generating, based on the cabinet assembly inventory, a meal cabinet assembly configuration corresponding to the final meal configuration, wherein the meal cabinet assembly configuration indicates the number of each of the first cabinet assemblies, the second cabinet assemblies, and the third cabinet assemblies, which are required for storing the meals in the final meal configuration; acquiring an additional requirement of the airline for the flight, wherein the additional requirement comprises at least one of whether baggage deposit is required, the size of a space required for baggage deposit, whether pet deposit is required, and the size of a space required for pet deposit; determining a galley cabinet assembly configuration of the aircraft galley based on the accommodating space, the meal cabinet assembly configuration, the cabinet assembly inventory, and the additional requirement, wherein the galley cabinet assembly configuration indicates the number of each of the first cabinet assemblies, the second cabinet assemblies, and the third cabinet assemblies, which are recommended to be applied to the aircraft galley for the flight, and the arranged position of each cabinet assembly in each type of cabinet assemblies.

Further, according to one embodiment of the present application, the step of generating the initial meal configuration for the flight based on the information on the flight and the knowledge graph of the group passengers includes: using the information on the flight and the knowledge graph of the group passengers as input of a deep learning model, so as to output the initial meal configuration for the flight from the deep learning model, wherein the deep learning model has been trained in advance by using training data that includes training input data and training output data, the training input data includes information on a training flight and knowledge graphs of training passengers, and the training output data includes names of meals consumed on the training flight and quantities of corresponding meals.

Further, according to one embodiment of the present application, the first cabinet assembly is used for storing meals, the first cabinet assembly includes a sensor, the sensor is disposed on an inner wall of the first cabinet assembly and is configured to monitor amount of inventory of meals stored in the first cabinet assembly, and the method further includes: acquiring the amount of inventory of the meals in the first cabinet assembly monitored by the sensor before the flight takes off and after the flight lands; determining consumed amount of each meal on the flight from the amount of inventory of the meals before the flight takes off and the amount of inventory of the meals after the flight lands; and updating the deep learning model by using the information on the flight, the knowledge graph of the group passengers, and the consumed amount of each meal on the flight.

Further, according to one embodiment of the present application, the stored knowledge graphs of individual passengers are derived from historical meal data of the passengers on aircrafts, which is acquired from a database of the airline, historical ordering data of the passengers in restaurants, which is acquired from another database, and/or meal data browsed by the passengers on the Internet.

According to yet another aspect of the present application, further provided is an apparatus for configuring an aircraft galley, including: a first communication interface, which is used for receiving, from a database of an airline, information on a flight to be executed by an aircraft, configuration requirement of the airline for the flight, and historical on-board meal data of passengers on the flight, wherein the information on the flight includes departure date and time, origin and destination, flight duration, and a passenger list, and the configuration requirement comprises at least one of the following: whether meals are required, the types and quantities of the required meals, whether baggage deposit is required, the size of a space required for baggage deposit, whether pet deposit is required, and the size of a space required for pet deposit; a second communication interface, which is used for receiving, from a sensor disposed on an inner wall of a first cabinet assembly of the aircraft galley, amount of inventory of meals in the first cabinet assembly before the flight takes off and after the flight lands; a memory, which stores an airport meal inventory and a cabinet assembly inventory of a departure airport for the flight, wherein the airport meal inventory includes the types and quantities of meals available at the departure airport, and the cabinet assembly inventory includes the number of each of first cabinet assemblies, second cabinet assemblies, and third cabinet assemblies, which are available at the departure airport; and a passenger knowledge system, which is communicatively connected to the first communication interface, the second communication interface, and the memory, and is configured to perform the method for configuring the aircraft galley.

Further, according to one embodiment of the present application, the apparatus further includes: a third communication interface, which is used for acquiring additional passenger catering preference data from another database, and the additional passenger catering preference data includes historical ordering data of passengers in restaurants and/or meal data browsed by the passengers on the Internet.

Further, according to one embodiment of the present application, the passenger knowledge system includes a personalized knowledge graph and a deep learning model, and the passenger knowledge system is configured to: manage data from the first communication interface, the second communication interface and the third communication interface as a knowledge storage structure, and generate, by using the knowledge storage structure, decisional suggestions on the basis of the deep learning model, and the decisional suggestions include the final meal configuration and the galley cabinet assembly configuration of the aircraft galley.

Further, according to one embodiment of the present application, the personalized knowledge graph receives the data from the first communication interface, the second communication interface and the third communication interface, so as to generate adaptive knowledge graphs as the knowledge storage structure, wherein the adaptive knowledge graphs comprise the knowledge graphs of individual passengers and a knowledge graph of group passengers generated by clustering the knowledge graphs of a plurality of passengers, and the knowledge graph of the group passengers is used as input of the deep learning model for training, verification, offline or real-time prediction of the deep learning model.

In the embodiments of the present application, provided is an aircraft galley, including: a frame, which is attached to walls of a cabin of an aircraft in a horizontal axis direction of the aircraft and has an open accommodating space, wherein the accommodating space has a predetermined width in the horizontal axis direction, a predetermined length in a longitudinal axis direction of the aircraft, and a predetermined height in a vertical axis direction of the aircraft; one or more first cabinet assemblies, which are detachably connected to the frame; one or more second cabinet assemblies, which are detachably connected to the frame; and one or more third cabinet assemblies, which are detachably connected to the frame, wherein the sizes of the first cabinet assembly, the second cabinet assembly, the third cabinet assembly, and the accommodating space are in a predetermined proportion to each other, such that the accommodating space may be filled with different combinations formed by at least two of the first cabinet assemblies, the second cabinet assemblies, and the third cabinet assemblies, and the different combinations differ in at least one of the following aspects: types of cabinet assemblies, the number of each type of cabinet assemblies, and the arranged position of each cabinet assembly in each type of cabinet assemblies. Therefore, the problems in the prior art of it being difficult to improve the utilization efficiency of the aircraft galley and reduce the operation cost of the airline are at least solved, thereby realizing the effects of improving the utilization efficiency of the aircraft galley, reducing the operation cost of the airline, and providing more diverse and personalized passenger services.

### BRIEF DESCRIPTION OF THE DRAWINGS

The drawings, which constitute a part of the present application, are used for providing a further understanding of the present application, and schematic embodiments of the present application and descriptions thereof are used for explaining the present application, but do not constitute improper limitations to the present application. In the drawings:

FIG. 1 is a schematic structural diagram of a frame of an aircraft galley according to an embodiment of the present application;

FIG. 2 is a schematic structural diagram of an aircraft galley according to one embodiment of the present application;

FIG. 3 is a schematic structural diagram of an aircraft galley according to another embodiment of the present application;

FIG. 4 is a schematic structural diagram of an aircraft galley according to yet another embodiment of the present application;

FIG. 5 is a flowchart of a method for configuring an aircraft galley according to an embodiment of the present application;

FIGS. 6A and 6B, when viewed together, depict a diagram of a knowledge graph of an individual passenger and a knowledge graph of group passengers in a personalized knowledge graph applied by the present application; and

FIG. 7 is a block diagram of an apparatus for configuring an aircraft galley according to an embodiment of the present application.

### DETAILED DESCRIPTION

It should be noted that, in the case of no conflict, the embodiments in the present application and the features in the embodiments may be combined with each other. The present application will be described in detail below with reference to the drawings and in combination with the embodiments.

To assist the reader, the following parts list is provided:

| Number | Description |
|---|---|
| 100 | Aircraft galley |
| 110 | Frame |
| 111 | Accommodating space |
| 113 | Partition frame unit |
| 120 | First cabinet assembly |
| 130 | Second cabinet assembly |
| 140 | Third cabinet assembly |
| 150 | Fourth cabinet assembly |
| 160 | Fifth cabinet assembly |
| 170 | Sixth cabinet assembly |
| 180 | Seventh cabinet assembly |
| 190 | Eighth cabinet assembly |
| 210 | Ninth cabinet assembly |
| 600 | Apparatus for configuring aircraft galley |
| 610 | First communication interface |
| 620 | Second communication interface |
| 630 | Memory |
| 640 | Passenger knowledge system |
| 641 | Personalized knowledge graph |
| 642 | Deep learning model |
| 650 | Third communication interface |
| 660 | Information display device |

It should be pointed out that, unless otherwise specified, all technical and scientific terms used in the present application have the same meaning as commonly understood by those ordinary skilled in the art to which the present application belongs.

In present application, unless otherwise stated, orientation words used such as “up, down, top and bottom” are usually directed to directions shown in the drawings, or are directed to vertical, perpendicular or gravitational directions of components themselves; and similarly, for the convenience of understanding and description, “inside and outside” refer to inside and outside relative to the contours of the components themselves, but the above-mentioned orientation words are not used for limiting the present application.

The first objective of the present application is to configure an aircraft galley to be composed of a fixed frame and a plurality of detachable standardized cabinet assemblies, such that the cabinet assemblies of one aircraft galley may be detached for use in another aircraft galley when they will not be used on the next flight of the aircraft, whereby the cabinet assemblies of the aircraft galley may be shared between different aircrafts of an airline alliance, thereby reducing the galley costs of the aircrafts.

The second objective of the present application is to further set the sizes of different types of cabinet assemblies of the galley to be in a predetermined proportion to each other and in a predetermined proportion to an accommodating space of the galley, such that a plurality of cabinet assemblies may be configured in the frame of the galley in different combinations, and thus the galley may be freely configured.

The third objective of the present application is to further utilize a passenger knowledge system (PKS) containing a deep learning model, to customize an aircraft galley and corresponding on-board services for a particular flight to be executed by the aircraft, based on flight information, airline requirements and passenger preferences. Customizing the aircraft galley includes customizing a configuration for the meals and a configuration for galley cabinet assemblies, which are provided on the aircraft galley. That is, the customized aircraft galley may vary between different flights of the same aircraft, thereby maximizing the utilization efficiency of the space inside the aircraft galley, while providing more diverse services for passengers on the aircraft (including, but not limited to, personalized meal recommendation, additional baggage deposit, pet deposit, vending machine services, and the like), and thus improving the economic and environmental benefits of the airline.

The above objectives of the present application are implemented by a galley as a service (Galley As A Service, GAAS) for airlines. The GAAS is a platform connected to airlines and catering company databases that enhance the service blueprint for the operator, reduce food inventory, and diversify dining experiences onboard. With a shared service mode, GAAS reduces economic investment through a pay-per-use or pay-per-period subscription mode for the aircraft galley. GAAS may release some volume in the galley, the released volume may be reused for baggage or pet deposit, thus opening new profitable possibilities. In addition, GAAS uses intelligent technologies and a deep learning algorithm called the passenger knowledge system to provide more diverse and personalized meal (including food and beverage) choices, thereby reducing food waste on the aircraft. Through GAAS, the airlines may share galley equipment at an airline alliance level to configure aircraft galleys according to market demand, providing more choices to passengers through a variety of services, including food and beverage, additional baggage storage, pet storage, vending machines/third-party leased space and the like. In addition, with unneeded galley units removed, there can be significant environmental benefits and fuel savings associated with this configuration.

An aircraft galley according to an embodiment of the present application includes: a frame, which is attached to walls of a cabin of an aircraft in a horizontal axis direction of the aircraft and has an open accommodating space, wherein the accommodating space has a predetermined width in the horizontal axis direction, a predetermined length in a longitudinal axis direction of the aircraft, and a predetermined height in a vertical axis direction of the aircraft; one or more first cabinet assemblies, which are detachably connected to the frame; one or more second cabinet assemblies, which are detachably connected to the frame; and one or more third cabinet assemblies, which are detachably connected to the frame, wherein the sizes of the first cabinet assembly, the second cabinet assembly, the third cabinet assembly, and the accommodating space are in a predetermined proportion to each other, such that the accommodating space may be filled with different combinations formed by at least two of the first cabinet assemblies, the second cabinet assemblies, and the third cabinet assemblies, and the different combinations differ in at least one of the following aspects: types of cabinet assemblies, the number of each type of cabinet assemblies, and the arranged position of each cabinet assembly in each type of cabinet assemblies.

By setting the first cabinet assembly, the second cabinet assembly, and the third cabinet assembly to be detachably connected to the frame, the cabinet assemblies for the current flight of the aircraft may be detached for use in galleys of other aircrafts when it is determined that the cabinet assemblies will not be used on the next flight of the aircraft. Therefore, cabinet assemblies may be shared among different aircrafts, thereby reducing the costs of the aircraft galleys.

In addition, by setting the sizes of the first cabinet assembly, the second cabinet assembly, the third cabinet assembly, and the accommodating space to be in the predetermined proportion to each other, the accommodating space can be (partly or even fully) filled with different combinations formed by at least two of the first cabinet assemblies, the second cabinet assemblies, and the third cabinet assemblies. Therefore, the accommodating space may be configured by different combinations of cabinet assemblies, and thus the aircraft galley may be configured differently.

The cabinet assemblies according to the present application can be distinguished by the types of objects stored therein. Different types of cabinet assemblies (such as the first cabinet assemblies, the second cabinet assemblies, and the third cabinet assemblies) may be used for storing predetermined types of objects different from each other, which include any one of meals, garbage, electrical equipment for the galley, baggage, and pets. The types of the objects may be further subdivided, and the different subdivided types of objects may correspond to different types of cabinet assemblies. For example, the meal may be further divided into food and beverage, or may be further divided into meal requiring fresh-keeping and meal requiring no fresh-keeping. Obviously, it is conceivable that more types of cabinet assemblies are provided, for example, fourth cabinet assemblies, fifth cabinet assemblies, and the like. The size of the fourth cabinet assembly may be designed such that fourth cabinet assemblies may be combined with at least one of the first cabinet assemblies, the second cabinet assemblies, the third cabinet assemblies and the fifth cabinet assemblies, so as to fill (or even fully fill) the accommodating space. Other types of cabinet assemblies may be similarly designed.

That is, in the present application, by providing a plurality of types of modular cabinet assemblies, at least two types of cabinet assemblies may be used for filling the predetermined accommodating space of the aircraft galley like building blocks.

Further, the cabinet assemblies of the aircraft galley according to the present application may be divided into two types: cabinet assemblies installed with wheels and cabinet assemblies without wheels. The accommodating space may be partly or fully filled, by arranging the cabinet assemblies installed with wheels in a lower layer of the accommodating space and arranging the cabinet assemblies without wheels over the cabinet assemblies installed with wheels. In this case, the cabinet assemblies without wheels may also be detachably connected to the cabinet assemblies installed with wheels. In the present application, the detachable connection includes known ways of detachable mechanical connection such as threaded connection and snap connection.

In an exemplary embodiment of the present application, the cabinet assemblies installed with wheels, which are arranged in the lower layer, may be cabinet assemblies for storing meals, and the cabinet assemblies without wheels, which are arranged in the upper layer, may be used for placing electrical equipment for the galley (for example, a water heater, a microwave oven, an oven, and the like).

In the present application, filling the accommodating space includes any one of fully filling the accommodating space in three directions (i.e., a length direction Y, a width direction X and a height direction Z), fully filling the accommodating space in two directions, fully filling the accommodating space in one direction, and fully filling the accommodating space in none of the three directions.

In the present application, a sensor may also be disposed in the cabinet assembly, and the sensor may be used for monitoring parameters in the cabinet assembly, such as temperature, humidity, and amount of inventory of the object therein. For example, the sensor may be disposed on an inner wall of the cabinet assembly and is configured to monitor amount of inventory of the object, such as meals, stored in the corresponding cabinet assembly.

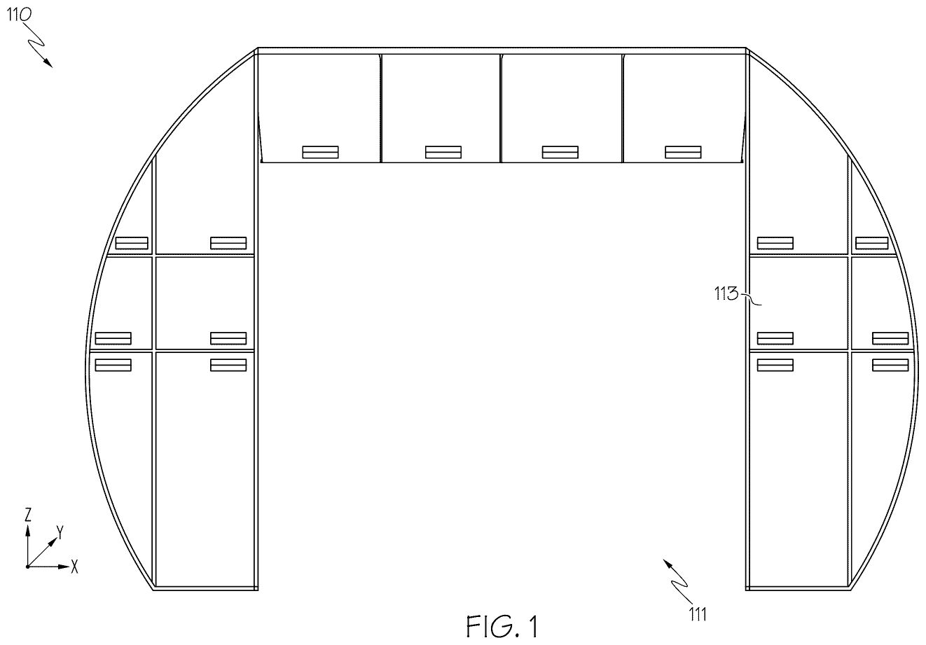

Next, specific embodiments of the present application will be described in detail with reference to FIGS. 1 to 7.

FIG. 1 is a schematic structural diagram of a frame of an aircraft galley according to an embodiment of the present application. As shown in FIG. 1, the frame 110 of the aircraft galley 100 according to the embodiment of the present application is attached to walls of a cabin of an aircraft in a horizontal axis direction (X direction) of the aircraft. Specifically, the two side surfaces of the frame 110 in the horizontal axis direction are attached to the walls of the cabin. In addition, the frame 110 is also attached to the ceiling and floor of the cabin, so as to be stably fixed in the cabin. The frame 110 may be disposed at any suitable position in the cabin as needed. The frame 110 includes an open accommodating space 111 and a plurality of partition frame units 113. The partition frame unit 113 may be used for disposing auxiliary equipment for the aircraft, such as emergency equipment, earphones, or the like. The accommodating space 111 is of a cuboid structure, and has a predetermined width in the horizontal axis direction, a predetermined length in a longitudinal axis direction (Y direction) of the aircraft, and a predetermined height in a vertical axis direction (Z direction) of the aircraft, so as to accommodate a plurality of standardized cabinet assemblies. In addition, the bottom and side surfaces of the frame 110 may be provided with guide strips, and corresponding positions of the cabinet assemblies may be provided with guide grooves, so that the cabinet assemblies may be easily pushed into or pulled out from the frame.

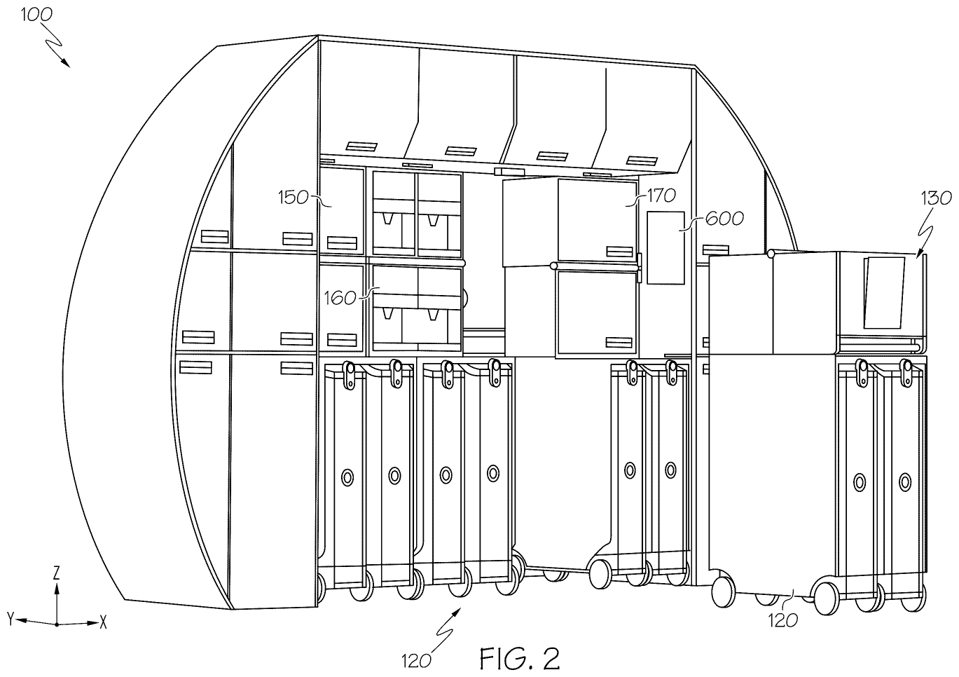

FIG. 2 is a schematic structural diagram of an aircraft galley according to one embodiment of the present application. As shown in FIG. 2, five types of cabinet assemblies are arranged in the accommodating space 111 of the aircraft galley 100, which are first cabinet assemblies 120, second cabinet assemblies 130, fourth cabinet assemblies 150, fifth cabinet assemblies 160, and sixth cabinet assemblies 170, respectively. FIG. 2 shows that four first cabinet assemblies 120 are arranged at the bottom of the accommodating space 111, and the fourth cabinet assemblies 150, the fifth cabinet assemblies 160, the second cabinet assemblies 130 and the sixth cabinet assemblies 170 are respectively arranged above the first cabinet assemblies 120. The first cabinet assembly 120 includes two identical cuboid units and a housing covering the two cuboid units. The cuboid unit is, for example, a trolley. The first cabinet assembly 120 (specifically, the housing of the first cabinet assembly 120) may be detachably connected to the fourth cabinet assembly 150, the fifth cabinet assembly 160, the second cabinet assembly 130, or the sixth cabinet assembly 170. The bottom of the first cabinet assembly 120 is installed with wheels, so that it is easy to push the first cabinet assembly 120 and other cabinet assemblies connected thereto into the frame or pull out the same from the frame. Further, adjacent cabinet assemblies in any direction may be detachably connected to each other. In addition, an external surface of the second cabinet assembly 130 in an XZ direction may be provided with a foldable handle, thereby facilitating the push-in and pull-out by a flight attendant. The first cabinet assembly 120 and the second cabinet assembly 130 have the same width, the length of the second cabinet assembly 130 is half of the length of the first cabinet assembly 120, and the sum of the height of the first cabinet assembly 120 and twice the height of the second cabinet assembly 130 is the height of the accommodating space 111. That is, one first cabinet assembly 120 and four second cabinet assemblies 130 may constitute one module unit of the aircraft galley 100 in the height direction, and the accommodating space 111 may be fully filled (i.e., fully filled in three directions) by four module units. That is, in addition to the combination shown in FIG. 2, a plurality of combinations formed by using at least two types of cabinet assemblies among the first cabinet assemblies 120, the second cabinet assemblies 130, the fourth cabinet assemblies 150, the fifth cabinet assemblies 160, and the sixth cabinet assemblies 170, can be used to fill the accommodating space 111. FIG. 2 also shows an apparatus 600 for configuring the aircraft galley that will be described later, and the apparatus may be embedded in a side wall of the frame 110 of the aircraft galley 100.

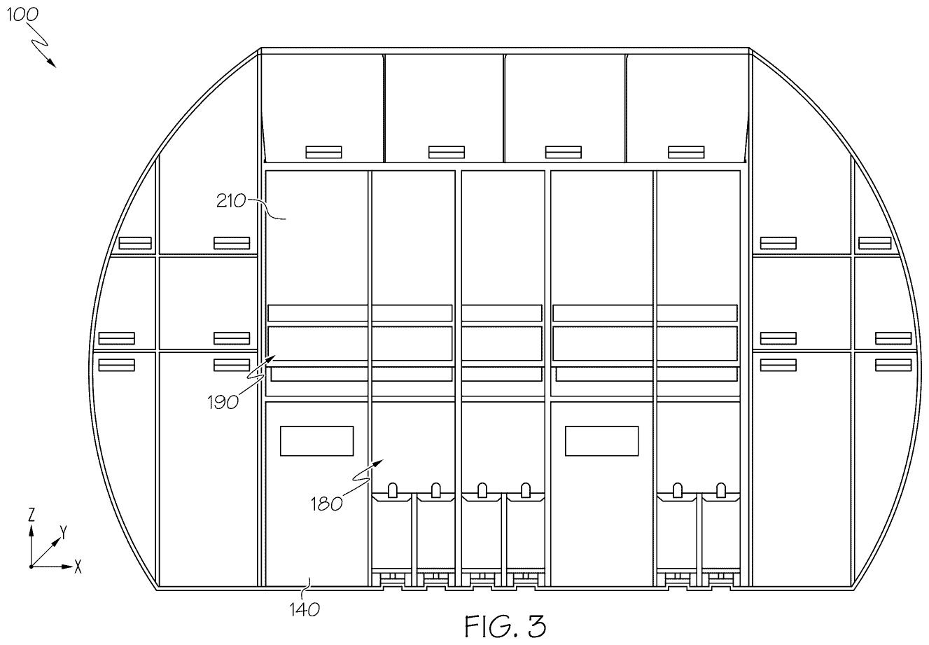

FIG. 3 is a schematic structural diagram of an aircraft galley according to another embodiment of the present application. As shown in FIG. 3, third cabinet assemblies 140, seventh cabinet assemblies 180, eighth cabinet assemblies 190, and ninth cabinet assemblies 210 are arranged in the accommodating space 111 of the aircraft galley 100. The accommodating space 111 is fully filled in the width direction and the height direction by arranging two first units and three second units in the width direction. The first unit includes one third cabinet assembly 140 located at the bottom, one eighth cabinet assembly 190 located at the middle, and one ninth cabinet assembly 210 located at the top. The second unit includes one seventh cabinet assembly 180 located at the bottom, one eighth cabinet assembly 190 located at the middle, and one ninth cabinet assembly 210 located at the top. Bottoms of the third cabinet assembly 140 and the seventh cabinet assembly 180 are installed with wheels. Adjacent cabinet assemblies in the height direction may be detachably connected to each other, and adjacent cabinet assemblies in the width direction may also be detachably connected to each other. The third cabinet assembly 140 and the seventh cabinet assembly 180 have the same size, but have different structural compositions. The third cabinet assembly 140 includes a single cuboid unit, while the seventh cabinet assembly 180 includes two smaller cuboid units located in the lower layer, and one cube unit located in the upper layer. Further, the third cabinet assembly 140 and the seventh cabinet assembly 180 may have the same size as the first cabinet assembly 120. In an exemplary embodiment of the present application, the third cabinet assembly 140 and the first cabinet assembly 120 may be used for, for example, storing meals, but are respectively used for storing meals requiring fresh-keeping and meals requiring no fresh-keeping, and the seventh cabinet assembly 180 may be used for, for example, accommodating garbage.

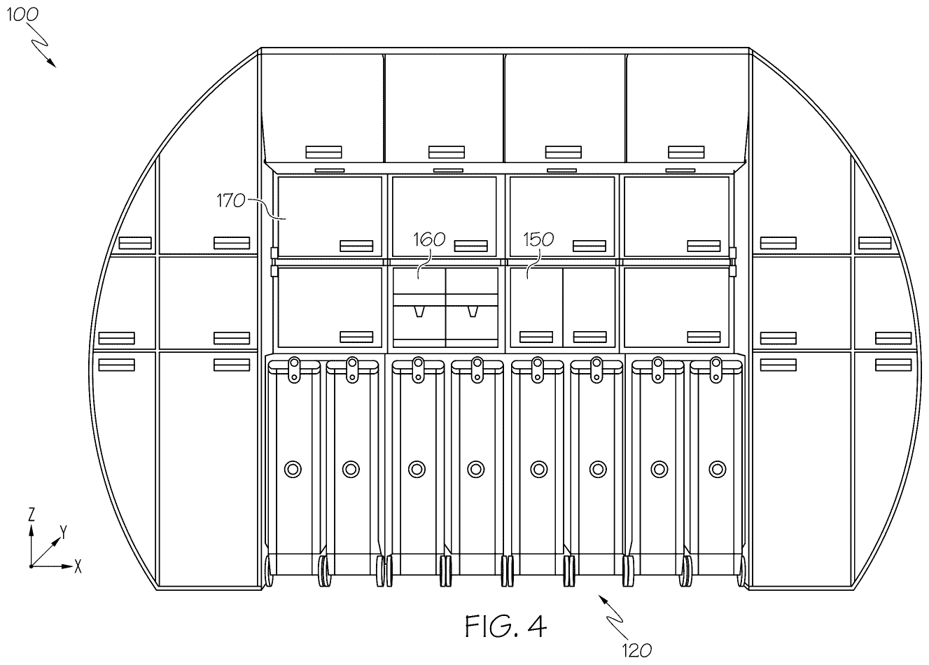

FIG. 4 is a schematic structural diagram of an aircraft galley according to yet another embodiment of the present application. Similar to FIG. 2, FIG. 4 shows that the bottom of the accommodating space 111 is filled with four first cabinet assemblies 120, but a plurality of fourth cabinet assemblies 150, fifth cabinet assemblies 160, and sixth cabinet assemblies 170, which are combined in a manner different from that shown in FIG. 2, are filled above the first cabinet assemblies 120.

Obviously, the sizes of the various cabinet assemblies are customized according to the size of the accommodating space, so that the sizes of different types of cabinet assemblies are in a predetermined proportion to each other, and the size of each cabinet assembly is in a predetermined proportion to the size of the accommodating space. In this way, the accommodating space can be filled with different combinations formed by at least two types of cabinet assemblies among the plurality of types of cabinet assemblies, and the aircraft galley may be freely configured.

Further, the aircraft galley may be configured based on knowledge graphs of passengers, the information on a flight to be executed by the aircraft, and the requirements of the airline for the flight.

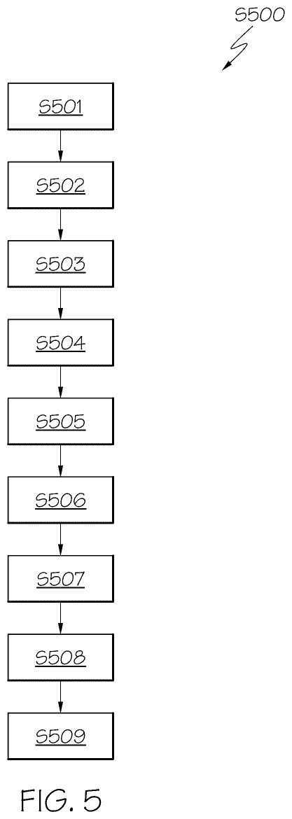

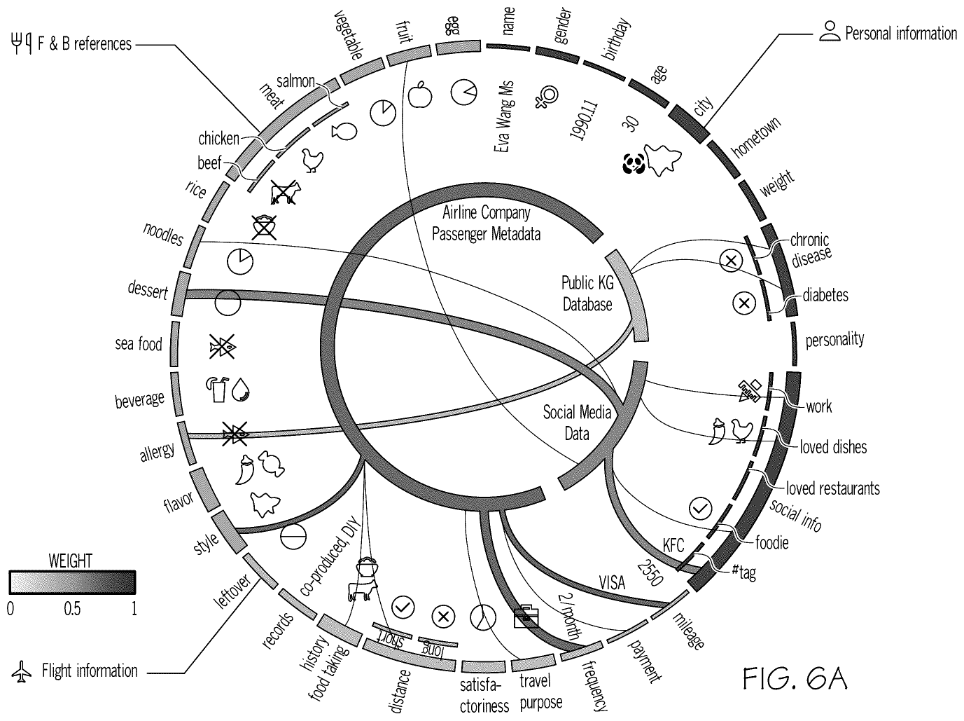

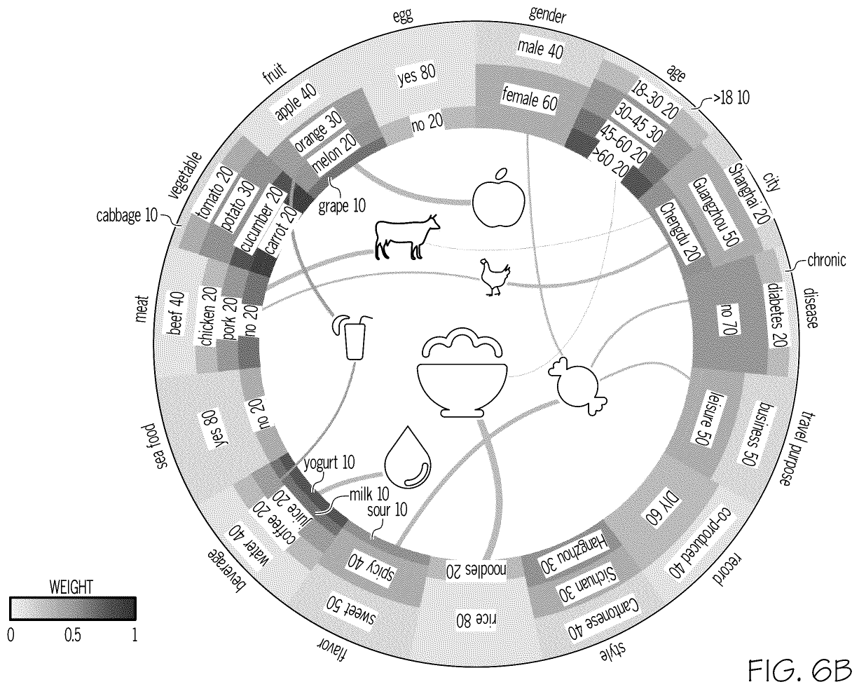

Next, a method for configuring an aircraft galley according to an embodiment of the present application is described. The method may be executed by a passenger knowledge system (e.g., located in a local computing apparatus or a cloud server). The passenger knowledge system includes a personalized knowledge graph (PKG) and a deep learning model. The passenger knowledge system may be configured to: receive data from a first communication interface, a second communication interface and a third communication interface, and store and manage the data as a knowledge storage structure; generate, by using the knowledge storage structure, decisional suggestions on the basis of the deep learning model. The decisional suggestions are used for supporting the configuration of cabinet assemblies of the aircraft galley and operation of the functions of the aircraft galley. The decisional suggestions include, but is not limited to, a final meal configuration and a galley cabinet assembly configuration of the aircraft galley. The decisional suggestions may further include, for example, on-board meal distribution guidance, on-board meal promotion, on-board meal permutation swap, and the like. Specifically, the personalized knowledge graph may be configured to: receive the data from the first communication interface, the second communication interface, and the third communication interface; and generate, based on the received data, adaptive knowledge graphs depending on a graph-type data structure and calculation logic, as the knowledge storage structure. The adaptive knowledge graphs include knowledge graphs of individual passengers, and a knowledge graph of group passengers generated by clustering the knowledge graphs of a specific plurality of passengers. The knowledge graph of the group passengers then may be used as input of the deep learning model for training, verification, and offline or real-time prediction of the deep learning model, which includes, but not limited to, generation of meal configuration for the aircraft galley. The method for configuring the aircraft galley, which is performed by the passenger knowledge system, will be described in detail below with reference to FIGS. 5, 6A and 6B. The aircraft galley includes, but is not limited to, the aircraft galley described with reference to FIGS. 2-4.

FIG. 5 is a flowchart of a method for configuring an aircraft galley according to an embodiment of the present application. As shown in FIG. 5, in the method S500, at the first, in S501, a catering configuration request from an airline for a flight to be executed by an aircraft and information on the flight may be received, wherein the information on the flight may include, but is not limited to, departure date and time, origin and destination, flight duration, and a passenger list. For example, the flight information may further include a flight number, an aircraft type, passenger seat distribution, and the like. Specifically, the information on the flight may be acquired by the personalized knowledge graph in response to the catering configuration request from the airline for the flight to be executed by a certain aircraft.

Then, in S502, a knowledge graph of group passengers corresponding to the flight may be generated based on the information on the flight and stored knowledge graphs of individual passengers, wherein the knowledge graph of an individual passenger indicates a personalized catering preference of the passenger, and the knowledge graph of the group passengers indicates a clustered catering preference of the passengers on the flight. Specifically, the personalized knowledge graph may retrieve, based on the passenger list in the information on the flight and from the knowledge storage structure thereof, the knowledge graph of each of the passengers corresponding to the flight, and cluster the knowledge graphs of these passengers to generate the knowledge graph of the group passengers corresponding to the flight.

FIGS. 6A and 6B depict a diagram of a knowledge graph of an individual passenger and a knowledge graph of group passengers generated by clustering the knowledge graphs of a plurality of passengers, in a personalized knowledge graph applied by the present application.

As shown in FIG. 6A, the knowledge graph of an individual passenger may be of a concentric double-ring structure. The inner ring indicates data sources of the graph, and the data sources may include, but are not limited to, passenger metadata from the airline, data from social media, a public knowledge graph database, and the like. The outer ring indicates a personalized catering preference of the individual passenger, which is output by the personalized knowledge graph by adaptively clustering metadata, which is from a plurality of data sources and is related to key entities.

The personalized catering preference of the individual passenger may include, but is not limited to, personal information, including name, gender, birthday, age, city, hometown, weight, disease, social information and the like; flight information, including mileage, payment, flight frequency, travel purpose, travel satisfactoriness, travel distance, on-board history food taking, on-board catering record, on-board leftover history, and the like; and catering preference information, including style, flavor, allergy, beverage, seafood, dessert, noodles, rice, meat, vegetable, fruit, egg, and the like. The correspondence between the output data on the outer ring and the data sources on the inner ring is represented by a connecting line. The association between two pieces of corresponding data is represented by graphs and symbols. For example, the connecting line between a keyword “allergy” and the public knowledge graph database indicates that the allergy information originates from the public knowledge graph database. A graphical fish, which is located on the right side of the word “allergy” and is labeled with a symbol “x”, indicates that the passenger is allergic to fish. Accordingly, although the preference of the passenger to seafood is not obtained, it may be inferred from the “allergy” information that the passenger does not cat fish, which is represented by a graphical fish that is located on the right side of the keyword “seafood” and is labeled with symbol “x”.

By clustering the knowledge graphs of a plurality of such individual passengers on the flight, the knowledge graph of group passengers corresponding to the flight may be generated, as shown in FIG. 6B. Specifically, by analyzing the units in the knowledge graph of each of the plurality of passengers, the knowledge graphs of the plurality of individual passengers may be converted into clustered catering preference of the group passengers on the flight. The knowledge graph of the group passengers is shown in the form of a matrix. FIG. 6B shows the knowledge graph of the group passengers by taking 100 passengers on a certain flight as an example. In the knowledge graph, passenger data is clustered into a plurality of units, including, but not limited to, gender, age, city, disease, travel purpose, on-board catering record, catering style, staple food, flavor, beverage, seafood, meat, vegetable, fruit, egg, and the like. Each unit is classified into several categories in different ways. The number listed behind each category represents the number of people corresponding to the category. The size of a cell occupied by each category also represents the corresponding number of people. The depth of a gray scale of the cell occupied by each category represents a weight occupied by the category in calculation, and the value of the weight is obtained by integrating various factors on the passengers.

For example, unit “egg” is divided into two categories of yes and no. There are 80 passengers in the category “yes”, which indicates that they may eat eggs, and there are 20 passengers in the category “no”, which indicates that they cannot eat eggs (for example, due to allergy or other reasons). Although the number of passengers who cannot eat eggs is fewer, since eggs have a great influence on the body, the category “no” occupies a greater weight compared with the category “yes”, and thus is represented in a darker color. This means that the probability of the meals containing eggs on that flight is relatively low.

In addition, the data in different units may be comprehensively analyzed to generate a common meal. For example, there are 60 women among the passengers, 70 passengers have no disease, the travel purpose of 50 passengers is leisure, and the flavor of 50 passengers is sweet, therefore, it may be derived that the common characteristic of those passengers is preferring candies, as shown by a candy graph through which the several units are connected together. This means that the probability of providing candies in this flight is relatively high.

Next, in S503, an initial meal configuration for the flight may be generated based on the information on the flight and the knowledge graph of the group passengers, wherein the initial meal configuration indicates the name of each meal recommended to be supplied on the flight, and the quantities of corresponding meals. Generating the initial meal configuration includes: using the information on the flight and the knowledge graph of the group passengers as the input of the deep learning model, so as to output the initial meal configuration for the flight from the deep learning model. The meal configuration for each passenger corresponding to the initial meal configuration may be further generated.

In the present application, the deep learning model has been trained in advance by using training data that includes training input data and training output data. The training input data includes information on a training flight and predetermined knowledge graphs of training passengers (including knowledge graphs of individual training passengers, and a knowledge graph of group training passengers corresponding to the training flight), and the training output data includes names of meals actually consumed on the training flight and quantities of corresponding meals. The training output data may further include name and quantity of meal actually consumed by each of the training passengers on the training flight.

In the present application, by acquiring the flight information, for example, it is possible to determine the season in which the flight is located, whether the time of takeoff of the flight is in the morning, at noon, or in the evening of one day, how many dinners will be taken during the flight, whether there are special passengers (for example, elderly, children, and the like), and the local specialties at the place of departure of the flight. In this way, the generated initial meal configuration may vary with passenger category, the season in which the flight is located, the time in one day where the flight is located, the flight duration, the place of departure, and the like.

In the present application, the initial meal configuration may be iteratively generated. For example, in response to a flight plan change (e.g., a time of takeoff change, an aircraft type change, and the like) and/or a passenger change (e.g., a passenger list change), the knowledge graph of the group passengers may be regenerated according to the information on the flight updated in real time and the knowledge graph of each passenger, so as to regenerate the initial meal configuration.

After the initial meal configuration is generated, in S504, an accommodating space of the aircraft galley and an airport meal inventory of a departure airport for the flight may be acquired, wherein the airport meal inventory includes the types and quantities of meals available at the departure airport. Specifically, the accommodating space of the aircraft galley may be determined from the aircraft type indicated by the flight information.

Then, in S505, the initial meal configuration may be modified based on the airport meal inventory and the accommodating space of the aircraft galley, so as to obtain a final meal configuration. For example, the initial meal configuration may be compared with the airport meal inventory, if a certain meal (e.g., salmon) in the initial meal configuration has no inventory at the departure airport, a similar meal (e.g., tuna) may be retrieved from the airport meal inventory for replacement. In addition, after the meal configuration is generated, the electrical equipment for the galley corresponding to the meal configuration may be determined. Therefore, the accommodating space required to accommodate meals in the meal configuration and the electrical equipment for the galley thereof (such as an electric water heater, a microwave oven, a garbage can, and the like) may be determined. The accommodating space of the aircraft galley may be compared with the accommodating space required for the initial meal configuration and the electrical equipment for the galley thereof. If the accommodating space of the aircraft galley is greater, there is no need to adjust the meal configuration; and if the accommodating space of the aircraft galley is smaller, a meal, which is greater in volume and less in preference, such as orange juice, may be removed. Through the above-mentioned modification, it is possible to obtain the final meal configuration, which can match the volume of the aircraft galley and may be provided at the departure airport. The final meal configuration indicates the name of each meal recommended to be supplied on the flight and the quantities of the corresponding meals. The final meal configuration may also indicate a passenger name corresponding to each meal recommended for supply.

Then, in S506, a cabinet assembly inventory of the departure airport may be acquired, wherein the cabinet assembly inventory includes the number of each of first cabinet assemblies, second cabinet assemblies, and third cabinet assemblies, which are available at the departure airport. Obviously, referring to the description of FIGS. 2 to 4, the cabinet assembly inventory may further include more types of cabinet assemblies.

Then, in S507, a meal cabinet assembly configuration corresponding to the final meal configuration may be generated based on the cabinet assembly inventory, wherein the meal cabinet assembly configuration indicates the number of each of the first cabinet assemblies, the second cabinet assemblies, and the third cabinet assemblies, which are required for storing the meals in the final meal configuration. Further, the meal cabinet assembly configuration further indicates the types of cabinet assemblies required to store the electrical equipment for the galley associated with the final meal configuration, and the number of each type of cabinet assemblies.

Then, in S508, an additional requirement of the airline for the flight may be acquired, wherein the additional requirement includes at least one of whether baggage deposit is required, the size of a space required for baggage deposit, whether pet deposit is required, and the size of a space required for pet deposit. The additional requirement may further include whether a leased space for vending machine service is required, and the size of a corresponding space, etc.

Then, in S509, a galley cabinet assembly configuration of the aircraft galley may be determined based on the accommodating space, the meal cabinet assembly configuration, the cabinet assembly inventory, and the additional requirement, wherein the galley cabinet assembly configuration indicates the number of each of the first cabinet assemblies, the second cabinet assemblies, and the third cabinet assemblies, which are recommended to be applied to the aircraft galley for the flight, and the arranged position of each cabinet assembly in each type of cabinet assemblies. Specifically, in the case where the space required by the meal cabinet assembly configuration is less than the accommodating space, the remaining space of the aircraft galley may be used for providing other services other than meals (including baggage deposit, pet deposit, vending machine placement, and the like). At this time, the passenger knowledge system may select, based on the additional requirement of the airline and from the cabinet assembly inventory, at least one additional cabinet assembly, which is suitable for the additional requirement and does not exceed the size of the remaining space. The cabinet assemblies indicated by the meal cabinet assembly configuration and the additional cabinet assemblies constitute cabinet assemblies for the aircraft galley. Then, the position of each of cabinet assemblies in the aircraft galley may be configured based on the type and size of each of cabinet assemblies. For example, the cabinet assemblies installed with wheels are suitable for being arranged in the lower layer of the accommodating space, and the cabinet assemblies without wheels are suitable for being arranged in the upper layer. In addition, the cabinet assembly, which is provided with a foldable handle and is operated by a flight attendant, is suitable for being arranged in the upper layer. Preferably, the galley cabinet assemblies fully fill the accommodating space in at least two directions (e.g., X and Y directions), so as to make full use of the accommodating space. Preferably, a layout diagram containing position of each of cabinet assemblies in the accommodating space may be generated, so as to intuitively indicate the arranged position of each of the cabinet assemblies.

Processing and services that the passenger knowledge system may execute before the flight takes off have been described above. However, the functions of the passenger knowledge system are not limited thereto. During the flight and after landing, the passenger knowledge system may still provide corresponding on-board services and post-flight services.

For example, during the flight, the passenger knowledge system may generate a corresponding meal for each seat based on passenger names corresponding to each meal recommended for supply, which are indicated by the generated final meal configuration, and passenger seat distribution indicated by the flight information. The meal corresponding to the passenger on each seat may be intuitively displayed on a passenger seat distribution diagram in the form of a graph. That is, the passenger knowledge system may be connected to a display terminal (which is an example of an information display device 660 that will be described later), and the passenger seat distribution marked with the corresponding meal may be displayed on the display terminal. Thus, the flight attendant may intuitively understand the meal of each passenger and efficiently distribute meals during the flight. Further, the passenger knowledge system may determine, according to the passenger seat distribution before takeoff, the position where each meal in the final meal configurations should be located in the cabinet assembly (that is, located in which box in which cabinet assembly, for example, which box from top to bottom in a trolley), and illustrate the position. Therefore, the flight attendant may directly distribute meals in sequence according to an arrangement sequence in the trolley when distributing meals, that is, meals may be efficiently distributed. This is particularly effective in cases of a large aircraft and numerous passengers.

In addition, in the present application, a sensor may be installed in the cabinet assembly for storing meals. The sensor may be disposed on an inner wall of the cabinet assembly and is configured to monitor amount of a real-time inventory of meals stored in the cabinet assembly. By using the data from the sensor within each such cabinet assembly, the passenger knowledge system may grasp a real-time on-board meal inventory during the flight. This helps to reduce the remaining inventory of meals on-board and avoid food waste. Moreover, this may be particularly useful in the case of paid meals. Some flights do not provide free meals at present. During the flight, there may be only some passengers purchasing meals. In the case of mastering the real-time on-board meal inventory, the passenger knowledge system may customize promotion activity for food with a relatively large inventory, so as to reduce food waste and increase profits at the same time.

In addition, the meals (especially staple food set meals) are typically stored in boxes in the cabinet assemblies (e.g., trolleys) from top to bottom. During the flight, after dining is finished, the flight attendant needs to recycle the meal packages from the passengers into the cabinet assemblies as they were. Therefore, the sensor may be further used for monitoring the real-time remaining amount of leftover of each meal stored in the cabinet assemblies after the meal packages are recycled, properly speaking, monitoring the amount of leftover in each of boxes in the cabinet assemblies. Since the flight attendant may recycle the meal packages in sequence, each of boxes in the cabinet assemblies corresponds to a particular passenger. Therefore, according to the monitored amount of leftovers, the passenger knowledge system may know the amount of leftover of each of the passengers, so as to update the knowledge graph of each of the passengers, that is, to realize adaptive knowledge graphs.

In addition, a meal selection emergency by a passenger may occur during the flight. That is, the passenger may not want the recommended meal, although the meal is what he ever preferred. In contrast, a passenger may want to attempt a new meal that he has not experienced. At this time, in order to better serve all passengers on-board, the passenger knowledge system may receive the meal selection emergency, and update, in real time, the on-board meal inventory and a list of remaining passengers whose meals are not distributed. The passenger knowledge system may redistribute, by means of an algorithm, the on-board meal inventory to the remaining passengers based on the updated on-board meal inventory and the list of remaining passengers, thereby providing emergency solutions for meeting the group passengers with limitation. The distribution may be based on the knowledge graph of each passenger. At the same time, the meal selection emergency may be recorded for updating the knowledge graph of the corresponding passenger.

In addition, after landing, the passenger knowledge system may receive, from the sensors, remaining amount of inventories of on-board meals after landing, and determine the consumed amount of each of meals, that is, the name of each of meals and consumed quantities of corresponding meals, during the flight based on the remaining amount of inventory of each meal and the amount of inventory of each meal before takeoff.

Then, the passenger knowledge system may verify, or train and update the deep learning model by using the data of the present flight as new training data. That is, the deep learning model may be verified or updated by using the information of the present flight, the knowledge graph of the group passengers on the present flight, and the consumed amount of each meal on the present flight. Specifically, the information on the flight, and the knowledge graph of the group passengers which is updated in real time and is generated from the real-time updated knowledge graph of each passenger on the flight, may be used as the input of the deep learning model. Then, an output may be acquired from the deep learning model, and the output may be compared with the actual consumption of each of meals on the flight, so as to verify the deep learning model. In addition, the information on the flight and the updated knowledge graph of the group passengers may be used as training input of the deep learning model, and the name of each actually consumed meal during the flight and the corresponding quantity may be used as a training output, so as to train the deep learning model. Therefore, the deep learning model may be continuously optimized by using new data, thereby realizing increasingly accurate personalized meal recommendation.

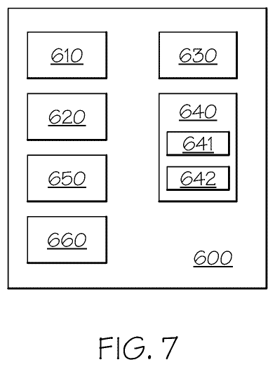

The method S500 for configuring the aircraft galley according to the embodiment of this application may be performed by an apparatus 600. The apparatus 600 may be a local computing apparatus or a cloud server. When the apparatus 600 is a local computing apparatus, it may be installed in the aircraft galley, for example, being embedded in a sidewall of the frame 110, as shown in FIG. 2. FIG. 7 is a block diagram of an apparatus for configuring an aircraft galley according to an embodiment of the present application. As shown in FIG. 7, the apparatus 600 for configuring the aircraft galley may include: a first communication interface 610, which is used for receiving, from a database of an airline, information on a flight to be executed by an aircraft, configuration requirement of the airline for the flight to be executed by the aircraft, and historical on-board meal data of passengers on the flight, wherein the information on the flight includes departure date and time, origin and destination, flight duration, and a passenger list, and the configuration requirement includes at least one of the following: whether meals are required, the types and quantities of the required meals, whether baggage deposit is required, the size of a space required for baggage deposit, whether pet deposit is required, and the size of a space required for pet deposit; a second communication interface 620, which is used for receiving, from a sensor disposed on an inner wall of a cabinet assembly for storing meals of the aircraft galley, amount of inventory of meals in the cabinet assembly before the flight takes off and after the flight lands; a memory 630, which stores an airport meal inventory and a cabinet assembly inventory of a departure airport for the flight, wherein the airport meal inventory includes the types of meals available at the departure airport and the quantity of each meal, and the cabinet assembly inventory includes the number of each of first cabinet assemblies, second cabinet assemblies, and third cabinet assemblies, which are available at the departure airport; and a passenger knowledge system 640, which is communicatively connected to the first communication interface 610, the second communication interface 620, and the memory 630, and is configured to perform the method for configuring the aircraft galley according to the embodiment of the present application.

The apparatus 600 may further include a third communication interface 650 which is used for acquiring additional passenger catering preference data from another database. The additional passenger catering preference data includes historical ordering data of passengers in restaurants and/or meal data browsed by the passengers on the Internet. By using such additional passenger catering preference data, the accuracy of personalized catering preferences of the passengers indicated by the knowledge graphs may be improved, thereby improving the on-board catering experience of the passengers.

The passenger knowledge system 640 may include a personalized knowledge graph 641 and a deep learning model 642, and the personalized knowledge graph 641 and the deep learning model 642 have been described above with reference to FIG. 5 and FIGS. 6A and 6B, and thus will not be repeated herein.

The apparatus 600 may also include an information display device 660 for displaying various decisional suggestions generated by the passenger knowledge system 640, including, but not limited to, a galley cabinet assembly configuration of the aircraft galley, where each copy of meal in the final meal configuration should be located in the cabinet assembly (i.e., located in which box in which cabinet assembly, for example, which box from top to bottom in the trolley), passenger seat distribution on the flight marked with a corresponding meal icon, and the like. By using the information display device 660, various decisional suggestions may be shown in an illustration, thereby facilitating the flight attendant to view and obtain guidance. The information display device 660 may also serve as a user interface to receive an input from the flight attendant (e.g., a meal selection emergency of an on-board passenger) and output (e.g., redistribution of meals for on-board passengers).

In the present application, the aircraft galley, and the method and apparatus for configuring the aircraft galley may be operated by a third party other than the airline. That is, the airline may use various modular cabinet assemblies of the aircraft galley in a leasing mode of pay-per-use or pay-per-period, thereby reducing aircraft investment costs. At the same time, the aircraft galley allows a part of the space to be released for diversified on-board services (such as baggage or pet deposit, and increasing vending machines), thereby bringing new profitable possibilities for the airline, and thus improving the economic benefits of the airline. In addition, in the present application, various modular cabinet assemblies of the aircraft galley may be shared at an alliance level, thereby reducing the production requirements for the cabinet assemblies, and thus improving the environmental benefits.

It should be noted that, terms used herein are for the purpose of describing specific embodiments, and are not intended to limit the exemplary embodiments according to the present application. As used herein, unless the context clearly dictates otherwise, a singular form is intended to include a plural form as well. In addition, it should also be understood that, when the terms “containing” and/or “including” are used in this specification, they indicate that the presence of features, steps, works, devices, assemblies and/or combinations thereof.

It should be noted that, the terms “first” and “second” and the like in the specification, claims and the above-mentioned drawings of the present application are used for distinguishing similar objects, and are not necessarily used for describing a specific sequence or precedence order. It should be understood that the data used in this way may be interchanged under appropriate circumstances, so that the embodiments of the present application described herein may be implemented in a sequence other than those illustrated or described herein.

The foregoing descriptions are only preferred embodiments of the present application, and are not intended to limit the present application, and for those skilled in the art, the present application may have various modifications and changes. Any modifications, equivalent replacements, improvements and the like, made within the spirit and principles of the present application, shall all be included in the protection scope of the present application.

What is claimed is:

1. An aircraft galley, comprising:
a frame, which is attached to walls of a cabin of an aircraft in a horizontal axis direction of the aircraft and has an open accommodating space, wherein the accommodating space has a predetermined width in the horizontal axis direction, a predetermined length in a longitudinal axis direction of the aircraft, and a predetermined height in a vertical axis direction of the aircraft;
one or more first cabinet assemblies, which are detachably connected to the frame;
one or more second cabinet assemblies, which are detachably connected to the frame; and
one or more third cabinet assemblies, which are detachably connected to the frame,
wherein the sizes of the first cabinet assembly, the second cabinet assembly, the third cabinet assembly, and the accommodating space are in a predetermined proportion to each other, such that the accommodating space can be filled with different combinations formed by at least two of the first cabinet assemblies, the second cabinet assemblies, and the third cabinet assemblies, and
the different combinations differ in at least one of the following aspects: types of cabinet assemblies, the number of each type of the cabinet assemblies, and the arranged position of each cabinet assembly in each type of cabinet assemblies.

2. The aircraft galley according to claim 1, wherein the accommodating space can be filled with different combinations formed by at least two of the first cabinet assemblies, the second cabinet assemblies, and the third cabinet assemblies comprises: the accommodating space can be fully filled with different combinations formed by at least two of the first cabinet assemblies, the second cabinet assemblies, and the third cabinet assemblies.

3. The aircraft galley according to claim 1, wherein the first cabinet assembly can be detachably connected to the second cabinet assembly.

4. The aircraft galley according to claim 3, wherein the first cabinet assembly can be detachably connected to the second cabinet assembly in a snap-fit manner, and wheels are installed at the bottom of the first cabinet assembly.

5. The aircraft galley according to claim 1, wherein the sizes of the first cabinet assembly, the second cabinet assembly, and the third cabinet assembly being in the predetermined proportion to each other comprises:
the first cabinet assembly, the second cabinet assembly, and the third cabinet assembly have the same width in the horizontal axis direction, and the length of the second cabinet assembly in the longitudinal axis direction is half of the length of the first cabinet assembly in the longitudinal axis direction.

6. The aircraft galley according to claim 1, wherein the sizes of the first cabinet assembly, the second cabinet assembly, and the third cabinet assembly being in the predetermined proportion to each other comprises: the first cabinet assembly and the third cabinet assembly has the same size, and
the first cabinet assembly and the third cabinet assembly have different structural compositions.

7. The aircraft galley according to claim 6, wherein the first cabinet assembly and the third cabinet assembly having different structural compositions comprises: the first cabinet assembly comprises two identical cuboid units and a housing covering the two cuboid units, and the third cabinet assembly comprises a single cuboid unit.

8. The aircraft galley according to claim 1, wherein each of the first cabinet assembly, the second cabinet assembly, and the third cabinet assembly is used for storing a predetermined type of object, and the object comprises any one of the following: meals, garbage, electrical equipment for the galley, baggage, and pets.

9. The aircraft galley according to claim 8, wherein at least one of the first cabinet assembly, the second cabinet assembly, and the third cabinet assembly further comprises a sensor, and the sensor is disposed on an inner wall of the corresponding cabinet assembly and is configured to monitor amount of inventory of object stored in the corresponding cabinet assembly.

10. The aircraft galley according to claim 8, wherein the combination, which is used for filling the accommodating space and is formed by at least two of the first cabinet assemblies, the second cabinet assemblies, and the third cabinet assemblies, varies with the flight of the aircraft.

11. The aircraft galley according to claim 10, wherein the combination, which is used for filling the accommodating space and is formed by at least two of the first cabinet assemblies, the second cabinet assemblies, and the third cabinet assemblies, is determined based on the information on a flight to be executed by the aircraft and a configuration requirement of an airline for the flight,
the information on the flight comprises departure date and time, origin and destination, flight duration and a passenger list, and
the configuration requirement for the flight comprises at least one of the following: whether meals are required, the types and quantities of the required meals, whether baggage deposit is required, the size of a space required for baggage deposit, whether pet deposit is required, and the size of a space required for pet deposit.

12. A method for configuring the aircraft galley according to claim 1, wherein the method comprises:
receiving a catering configuration request from an airline for a flight to be executed by an aircraft and information on the flight, wherein the information on the flight comprises departure date and time, origin and destination, flight duration, and a passenger list;
generating a knowledge graph of group passengers corresponding to the flight based on the information on the flight and stored knowledge graphs of individual passengers, wherein the knowledge graph of an individual passenger indicates a personalized catering preference of the passenger, and the knowledge graph of the group passengers indicates a clustered catering preference of the passengers on the flight;
generating an initial meal configuration for the flight based on the information on the flight and the knowledge graph of the group passengers, wherein the initial meal configuration indicates the name of each meal recommended to be supplied on the flight and the quantities of corresponding meals;
acquiring an accommodating space of the aircraft galley and an airport meal inventory of a departure airport for the flight, wherein the airport meal inventory comprises the types and quantities of meals available at the departure airport;
modifying the initial meal configuration based on the airport meal inventory and the accommodating space, so as to obtain a final meal configuration;
acquiring a cabinet assembly inventory of the departure airport, wherein the cabinet assembly inventory comprises the number of each of first cabinet assemblies, second cabinet assemblies, and third cabinet assemblies, which are available at the departure airport;
generating, based on the cabinet assembly inventory, a meal cabinet assembly configuration corresponding to the final meal configuration, wherein the meal cabinet assembly configuration indicates the number of each of the first cabinet assemblies, the second cabinet assemblies, and the third cabinet assemblies, which are required for storing the meals in the final meal configuration;
acquiring an additional requirement of the airline for the flight, wherein the additional requirement comprises at least one of whether baggage deposit is required, the size of a space required for baggage deposit, whether pet deposit is required, and the size of a space required for pet deposit;
determining a galley cabinet assembly configuration of the aircraft galley based on the accommodating space, the meal cabinet assembly configuration, the cabinet assembly inventory, and the additional requirement, wherein the galley cabinet assembly configuration indicates the number of each of the first cabinet assemblies, the second cabinet assemblies, and the third cabinet assemblies, which are recommended to be applied to the aircraft galley for the flight, and the arranged position of each cabinet assembly in each type of cabinet assemblies.

13. The method according to claim 12, wherein the step of generating the initial meal configuration for the flight based on the information on the flight and the knowledge graph of the group passengers comprises:
using the information on the flight and the knowledge graph of the group passengers as input of a deep learning model, so as to output the initial meal configuration for the flight from the deep learning model,
wherein the deep learning model has been trained in advance by using training data that comprises training input data and training output data, the training input data comprises information on a training flight and knowledge graphs of training passengers, and the training output data comprises names of meals consumed on the training flight and quantities of corresponding meals.

14. The method according to claim 13, wherein the first cabinet assembly is used for storing meals, the first cabinet assembly comprises a sensor, the sensor is disposed on an inner wall of the first cabinet assembly and is configured to monitor amount of inventory of meals stored in the first cabinet assembly, and the method further comprises:
acquiring the amount of inventory of the meals in the first cabinet assembly monitored by the sensor before the flight takes off and after the flight lands;
determining consumed amount of each meal on the flight from the amount of inventory of the meals before the flight takes off and the amount of inventory of the meals after the flight lands; and
updating the deep learning model by using the information on the flight, the knowledge graph of the group passengers, and the consumed amount of each meal on the flight.

15. The method according to claim 13, wherein the stored knowledge graphs of individual passengers are derived from historical meal data of the passengers on aircrafts, which is acquired from a database of the airline, historical ordering data of the passengers in restaurants, which is acquired from another database, and/or meal data browsed by the passengers on the Internet.

16. An apparatus for configuring an aircraft galley, wherein the apparatus comprises:
a first communication interface, which is used for receiving, from a database of an airline, information on a flight to be executed by an aircraft, configuration requirement of the airline for the flight, and historical on-board meal data of passengers on the flight, wherein the information on the flight comprises departure date and time, origin and destination, flight duration and a passenger list, and the configuration requirement comprises at least one of the following: whether meals are required, the types and quantities of the required meals, whether baggage deposit is required, the size of a space required for baggage deposit, whether pet deposit is required, and the size of a space required for pet deposit;
a second communication interface, which is used for receiving, from a sensor disposed on an inner wall of a first cabinet assembly of the aircraft galley, amount of inventory of meals in the first cabinet assembly before the flight takes off and after the flight lands;
a memory, which stores an airport meal inventory and a cabinet assembly inventory of a departure airport for the flight, wherein the airport meal inventory comprises the types and quantities of meals available at the departure airport, and the cabinet assembly inventory comprises the number of each of first cabinet assemblies, second cabinet assemblies, and third cabinet assemblies, which are available at the departure airport; and
a passenger knowledge system, which is communicatively connected to the first communication interface, the second communication interface, and the memory, and is configured to perform the method of claim 12.

17. The apparatus according to claim 16, wherein the apparatus further comprises:
a third communication interface, which is used for acquiring additional passenger catering preference data from another database, and the additional passenger catering preference data comprises historical ordering data of passengers in restaurants and/or meal data browsed by the passengers on the Internet.

18. The apparatus according to claim 17, wherein,
the passenger knowledge system comprises a personalized knowledge graph and a deep learning model, and the passenger knowledge system is configured to:
manage data from the first communication interface, the second communication interface, and the third communication interface as a knowledge storage structure, and
generate, by using the knowledge storage structure, decisional suggestions on the basis of the deep learning model, and the decisional suggestions comprise the final meal configuration and the galley cabinet assembly configuration of the aircraft galley.

19. The apparatus according to claim 18, wherein,
the personalized knowledge graph receives the data from the first communication interface, the second communication interface, and the third communication interface, so as to generate adaptive knowledge graphs as the knowledge storage structure.

20. The apparatus according to claim 19, wherein,
the adaptive knowledge graphs comprise knowledge graphs of individual passengers and a knowledge graph of group passengers generated by clustering the knowledge graphs of a plurality of passengers, and
the knowledge graph of the group passengers is used as input of the deep learning model for training, verification, and offline or real-time prediction of the deep learning model.
